(19) United States
(12) Patent Application Publication
(10) Pub. No.: US 2023/0073450 A1
(43) Pub. Date: Mar. 9, 2023

(54) METHOD AND SYSTEM FOR MACHINE LEARNING BASED PROFESSIONAL WRITTEN COMMUNICATION SKILL ASSESSMENT

(71) Applicant: Tata Consultancy Services Limited, Mumbai (IN)

(72) Inventors: TIRTHANKAR DASGUPTA, Kolkata (IN); LIPIKA DEY, Gurgaon (IN); ABIR NASKAR, Kolkata (IN)

(73) Assignee: Tata Consultancy Services Limited, Mumbai (IN)

(21) Appl. No.: 17/812,393

(22) Filed: Jul. 13, 2022

(30) Foreign Application Priority Data
Jul. 16, 2021 (IN) 202121032178

(51) Int. Cl. G06Q 10/06

(52) U.S. Cl. CPC G06Q 10/0639

(57) ABSTRACT

The present disclosure provides a method and system to evaluate professional written communication skill of the user. Conventional methods are based on regression methods which are inefficient. Initially, the system receives the textual data from the user and pre-process the textual data to obtain a clean textual data. Further, a plurality of linguistic features is computed from the clean data. A plurality of psychological features is simultaneously computed from the clean textual data based on a psycholinguistic analysis. Further, a concatenated feature vector is computed based on the plurality of linguistic features and plurality of psychological features by a first Fully Connected Neural Network (FCNN). A contextual embedding is simultaneously computed based on the clean textual data by a Bidirectional Encoding Representations from Transformers. Finally, a professional written communication skill of the user based is evaluated based on the concatenated feature vector and the contextual embedding by a second FCNN.

### PRIORITY CLAIM

This U.S. patent application claims priority under 35 U.S.C. § 119 to: Indian Patent Application No. 202121032178, filed on Jul. 16, 2021. The entire contents of the aforementioned application are incorporated herein by reference.

### TECHNICAL FIELD

The disclosure herein generally relates to the field of Natural language Processing (NLP) and, more particular, to a method and system for machine learning based professional written communication skill assessment.

### BACKGROUND

Good writing skills allows a person to communicate a message with clarity. The quality of written communication depends upon several linguistic factors corresponding to different properties like grammar, vocabulary, style, topic relevance, clarity, comprehensibility, informativeness, lexical diversity, discourse coherence, and cohesion. Further, there are some deeper cognitive and psychological features like types of syntactic constructions, grammatical relations, and measures of sentence complexity that decides the written communication skill. Communication skill analysis have been extremely important for an organization. Further with overall advancement in the field of automation, the automated communication skill analysis is also gaining popularity in the organizations that need to assess written communication skills among candidates on a regular basis.

Conventional methods for automated communication skill analysis are based on regression methods which are applied to a set of carefully designed complex linguistic and cognitive features. These regressions based methods requires knowledge of such complex features which are indistinguishable from that of human examiners. Further, it is challenging to exhaustively enumerate all factors that influence the quality of communication. Hence there is the challenge in assessing professional written communication skill of a user based on a written textual content.

### SUMMARY

Embodiments of the present disclosure present technological improvements as solutions to one or more of the above-mentioned technical problems recognized by the inventors in conventional systems. For example, in one embodiment, a method for machine learning based professional written communication skill assessment is provided. The method includes receiving, by one or more hardware processors, a textual data written by a user, wherein the textual data comprises a plurality of sentences. Each of the plurality of sentences includes a plurality of words. Further, the method includes obtaining, by the one or more hardware processors, a clean textual data by eliminating a plurality of irrelevant data from the textual data. Furthermore, the method includes computing, by the one or more hardware processors, a plurality of linguistic features based on the clean textual data using a linguistic analysis technique, wherein the plurality of linguistic features comprises a plurality of dependency relationship values, a text coherence value and a lexical diversity value, wherein the text coherence value is computed based on a moving average semantic similarity and the lexical density score is computed based on a phrasal density. Furthermore, the method includes simultaneously computing, by the one or more hardware processors, a plurality of psychological features based on the clean textual data using a psycholinguistic analysis. Furthermore, the method includes computing, by the one or more hardware processors, a concatenated feature vector based on the plurality of linguistic features and plurality of psychological features using a first Fully Connected Neural Network (FCNN). Furthermore, the method includes simultaneously computing, by the one or more hardware processors, a contextual embedding based on the clean textual data using a Bidirectional Encoding Representations from Transformers (BERT) technique. Finally, the method includes evaluating, by the one or more hardware processors, a professional written communication skill of the user based on the concatenated feature vector and the contextual embedding using a second FCNN.

In another aspect, a system for machine learning based professional written communication skill assessment is provided. The system includes at least one memory storing programmed instructions, one or more Input/Output (I/O) interfaces, and one or more hardware processors operatively coupled to the at least one memory, wherein the one or more hardware processors are configured by the programmed instructions to receive a textual data written by a user. The textual data includes a plurality of sentences. Each of the plurality of sentences includes a plurality of words. Further, the one or more hardware processors are configured by the programmed instructions to obtain a clean textual data by eliminating a plurality of irrelevant data from the textual data. Furthermore, the one or more hardware processors are configured by the programmed instructions to compute a plurality of linguistic features based on the clean textual data using a linguistic analysis technique, wherein the plurality of linguistic features comprises a plurality of dependency relationship values, a text coherence value and a lexical diversity value, wherein the text coherence value is computed based on a moving average semantic similarity and the lexical density score is computed based on a phrasal density. Furthermore, the one or more hardware processors are configured by the programmed instructions to compute a plurality of psychological features based on the clean textual data using a psycholinguistic analysis. Furthermore, the one or more hardware processors are configured by the programmed instructions to compute a concatenated feature vector based on the plurality of linguistic features and plurality of psychological features using a first Fully Connected Neural Network (FCNN). Furthermore, the one or more hardware processors are configured by the programmed instructions to simultaneously compute a contextual embedding based on the clean textual data using a Bidirectional Encoding Representations from Transformers (BERT) technique. Finally, the one or more hardware processors are configured by the programmed instructions to evaluate a professional written communication skill of the user based on the concatenated feature vector and the contextual embedding using a second FCNN.

In yet another aspect, a computer program product including a non-transitory computer-readable medium having embodied therein a computer program for machine learning based professional written communication skill assessment is provided. The computer readable program, when executed on a computing device, causes the computing device to receive a textual data written by a user. The textual data includes a plurality of sentences. Each of the plurality of sentences includes a plurality of words. Further, computer readable program, when executed on a computing device, causes the computing device to obtain a clean textual data by eliminating a plurality of irrelevant data from the textual data. Furthermore, computer readable program, when executed on a computing device, causes the computing device to compute a plurality of linguistic features based on the clean textual data using a linguistic analysis technique, wherein the plurality of linguistic features comprises a plurality of dependency relationship values, a text coherence value and a lexical diversity value, wherein the text coherence value is computed based on a moving average semantic similarity and the lexical density score is computed based on a phrasal density. Furthermore, computer readable program, when executed on a computing device, causes the computing device to compute a plurality of psychological features based on the clean textual data using a psycholinguistic analysis. Furthermore, computer readable program, when executed on a computing device, causes the computing device to compute a concatenated feature vector based on the plurality of linguistic features and plurality of psychological features using a first Fully Connected Neural Network (FCNN). Furthermore, computer readable program, when executed on a computing device, causes the computing device to simultaneously compute a contextual embedding based on the clean textual data using a Bidirectional Encoding Representations from Transformers (BERT) technique. Finally, computer readable program, when executed on a computing device, causes the computing device to evaluate a professional written communication skill of the user based on the concatenated feature vector and the contextual embedding using a second FCNN.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for machine learning based professional written communication skill assessment, in accordance with some embodiments of the present disclosure.

FIGS. 2A and 2B are exemplary flow diagrams illustrating a method for machine learning based professional written communication skill assessment, implemented by the system of FIG. 1, in accordance with some embodiments of the present disclosure.

FIG. 3 is a functional block diagram for text coherence computation for the processor implemented method for machine learning based professional written communication skill assessment implemented by the system of FIG. 1, in accordance with some embodiments of the present disclosure.

FIG. 4 illustrates the machine learning architecture for evaluating professional written communication skill implemented by the system of FIG. 1, in accordance with some embodiments of the present disclosure.

FIG. 5 is an example of overall architecture for the processor implemented method for machine learning based professional written communication skill assessment implemented by the system of FIG. 1, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Embodiments herein provide a method and system for machine learning based professional written communication skill assessment for assessing writing skills of a user. Initially, the system receives the textual data from the user and the textual data is pre-processed to obtain a clean textual data by removing a plurality of irrelevant data. Further, a plurality of linguistic features is computed from the clean data. The plurality of linguistic features includes a plurality of dependency relationship values, a text coherence value and a lexical diversity value. A plurality of psychological features is simultaneously computed from the clean textual data based on a psycholinguistic analysis. Further, a concatenated feature vector is computed based on the plurality of linguistic features and plurality of psychological features by a first Fully Connected Neural Network (FCNN). A contextual embedding is simultaneously computed based on the clean textual data by a Bidirectional Encoding Representations from Transformers (BERT) technique. Finally, a professional written communication skill of the user based is evaluated based on the concatenated feature vector and the contextual embedding by a second FCNN.

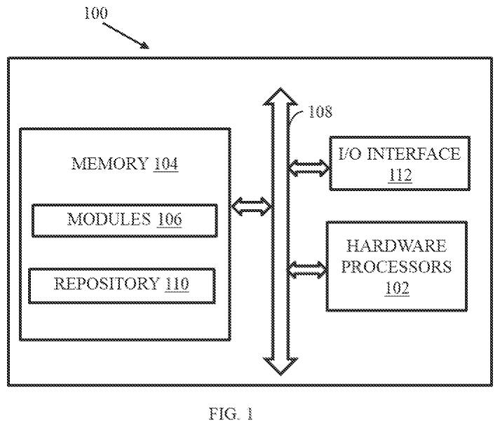

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a functional block diagram of a system 100 for machine learning based professional written communication skill assessment, according to some embodiments of the present disclosure. The system 100 includes or is otherwise in communication with hardware processors 102, at least one memory such as a memory 104, an I/O interface 112. The hardware processors 102, memory 104, and the input/Output (I/O) interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 104 includes a plurality of modules 106. The memory 104 also includes a data repository (or repository) 110 for storing data processed, received, and generated by the plurality of modules 106.

The plurality of modules 106 include programs or coded instructions that supplement applications or functions performed by the system 100 for machine learning based professional written communication skill assessment. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for machine learning based professional written communication skill assessment. In an embodiment, plurality of modules 106 includes a pre-processing module (not shown in FIG. 1), a linguistic processing module (not shown in FIG. 1) and a professional written communication skill evaluator module (not shown in FIG. 1).

The data repository (or repository) 110 may include a plurality of abstracted piece of code for refinement and data that is processed, received, or generated as a result of the execution of the plurality of modules in the module(s) 106.

Although the data repository 110 is shown internal to the system 100, it will be noted that, in alternate embodiments, the data repository 110 can also be implemented external to the system 100, where the data repository 110 may be stored within a database (not shown in FIG. 1) communicatively coupled to the system 100. The data contained within such external database may be periodically updated. For example, new data may be added into the database (not shown in FIG. 1) and/or existing data may be modified and/or non-useful data may be deleted from the database (not shown in FIG. 1). In one example, the data may be stored in an external system, such as a Lightweight Directory Access Protocol (LDAP) directory and a Relational Database Management System (RDBMS).

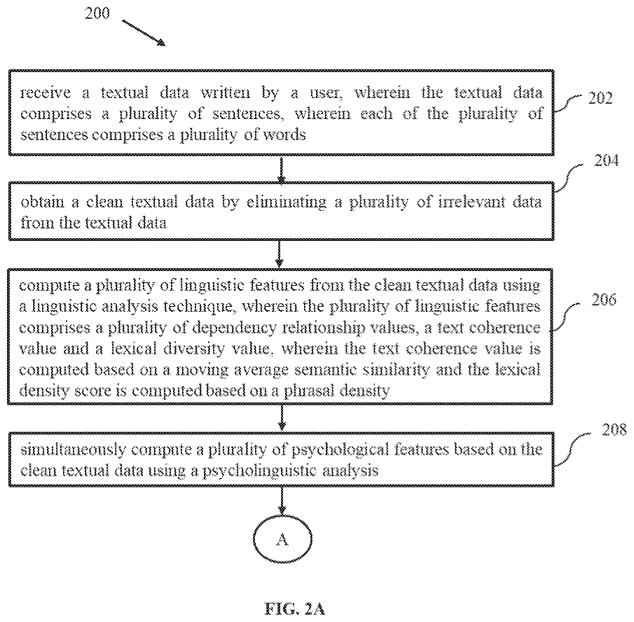

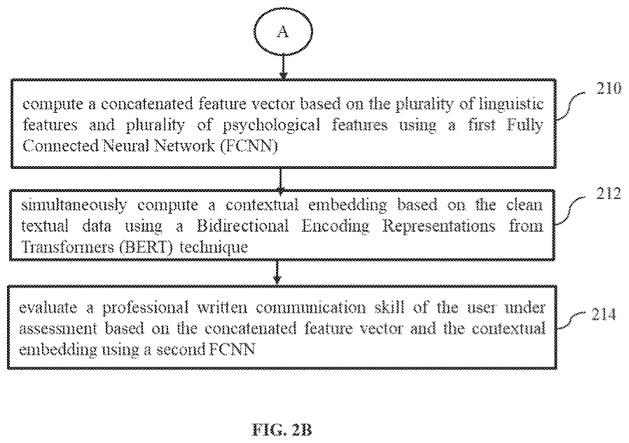

FIGS. 2A and 2B are exemplary flow diagrams illustrating a method 200 for machine learning based professional written communication skill assessment implemented by the system of FIG. 1 according to some embodiments of the present disclosure. In an embodiment, the system 100 includes one or more data storage devices or the memory 104 operatively coupled to the one or more hardware processor(s) 102 and is configured to store instructions for execution of steps of the method 200 by the one or more hardware processors 102. The steps of the method 200 of the present disclosure will now be explained with reference to the components or blocks of the system 100 as depicted in FIG. 1 and the steps of flow diagram as depicted in FIG. 2A and 2B. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communication network. The order in which the method 200 is described is not intended to be construed as a limitation, and any number of the described method blocks can be combined in any order to implement the method 200, or an alternative method. Furthermore, the method 200 can be implemented in any suitable hardware, software, firmware, or combination thereof.

At step 202 of the method 200, the one or more hardware processors 102 are configured by the programmed instructions to receive a textual data written by a user. The textual data includes a plurality of sentences. Each of the plurality of sentences includes a plurality of words. For example, the textual data is an English story about a given topic written by the user.

At step 204 of the method 200, the one or more hardware processors 102 are configured by the programmed instructions to obtain a clean textual data by eliminating a plurality of irrelevant data from the textual data. The plurality of irrelevant data includes a plurality of non-ASCII characters, a plurality of hyperlinks, a plurality of html tags, a plurality of URL markers, a plurality of line break markers and a plurality of details pertaining to the user under assessment. The plurality of details pertaining to the user includes a name, an address, an identification number, a phone number and an email ID.

At step 206 of the method 200, the one or more hardware processors 102 are configured by the programmed instructions to compute a plurality of linguistic features based on the clean textual data using a linguistic analysis technique. The plurality of linguistic features includes a plurality of dependency relationship values, a text coherence value and a lexical diversity value. The text coherence value is computed based on a moving average semantic similarity and the lexical density score is computed based on a phrasal density.

In an embodiment, the plurality of dependency relationships is computed using Stanford dependency parser. Each of the plurality of dependency relationships are associated with a corresponding dependency score. A dependency relationship is defined between a pair of grammatically related words within a sentence such as a Verb and its related arguments, or a Noun and its modifier. For example, given the textual data, the plurality of dependency relationships among the words are extracted using the Stanford dependency parser. Other tools like, Spacy dependency parsers, or CMU Link Parser can also be used for the same.

In an embodiment, the dependency relationships among the words in sentences can be represented as a Directed Acyclic Graph (DAG). Further, a plurality of structural properties like, a flatness, an embeddedness, a width of dependency, a depth of dependency, an average dependency distance and longest dependency distance are computed using the DAG.

In an embodiment, the flatness of a sentence is obtained by computing the average degree of each node (that represents a word) of the DAG. The degree of a node/word represents how many words are dependent on that particular word. The embeddedness is computed by closeness centrality or the count of number of nodes/words in between the root node and a given node. The width of dependency is a number of words that are dependent on one word. The depth of dependency is a number of words between the main verb and a given word.

In an embodiment, the dependency distance between a pair of related words is computed by counting the number of words that occur between the two words. For example, in the sentence “I went to the market to by a book” the dependency relations returned by the Stanford parser are nsubj (went-2, I-1), root(ROOT-0, went-2), case(market-5, to-3), det(market-5, the-4), obj(went-2, market-5), mark(buy-7, to-6), xcomp (went-2, buy-7), det(book-9, a-8) and obj(buy-7, book-9). Here, nsubj (went-2, I-1) indicates that the second word “went” is dependent on the 1^{st} word “I” and the type of relation is nSubj or nominal subject. Similarly, Det is determiner relation, obj is object, xcomp is open causal complement etc. From the above relations we compute the dependency distance between the word pairs “I” and “went” is 2−1=1. Therefore, the longest dependency distance in this sentence is as given in equation (1). The Average Dependency Distance (ADD) of a sentence is as given in equation (2) and the ADD of a document is as given in equation (3).

$$longest dependency distance = {∀}_{i , j} max ( distance ( {w}_{i} , {w}_{j} ) \qquad ( 1 )$$

$$A D D of a sentence = \frac{Sum of the distance of all the dependencies in the sentence}{\# of dependencies of the sentense} \qquad ( 2 )$$

$$A D D of a document = \frac{Sum of the A D D of the sentenses in the document}{\# of sentense in the document} \qquad ( 3 )$$

In an embodiment, the lexical density value is computed based on the phrasal density value as explained below: Initially, the method 200 receives the clean textual data. A plurality of key-phrases is obtained from the clean textual data by a key phrase extractor, for example, Rapid Automatic Keyword Extraction (RAKE). Each of the plurality of key-phrases is associated with a corresponding score. Further, a phrasal density value is computed based on a total number of key-phrases and a total number of phrases.

In an embodiment, the total number of key-phrases are computed based on the plurality of key-phrases using RAKE. RAKE is a standard phrase extractor tool that returns key phrases along with a score associated with each key phrase. The score is computed by taking the ratio between the degree of the constituent word in the cooccurrence matrix with the frequency of the constituent word. The total number of phrases are obtained from the clean textual data by computing a frequency of occurrence of Nouns, Verbs, Adjectives and Adverbial phrases by the Stanford Dependency Parsing Tool. Finally, the lexical diversity value is computed based on an average type-token ratio for each of the plurality of key-phrases and the phrasal density. The average type-token ratio is computed based on a ratio between a number of unique words in the clean textual data and a total number of words in the clean textual data. The formula for computing Phrasal Density (PD) value is represented in equation (3) and the Lexical Diversity (LD) is represented in equation (4), wherein MATTR is Moving Average Type-Token Ratio.

$$PD = \frac{\# of key - phrases in a document}{Total number of phrases} \qquad ( 3 )$$

$$L D = M A T T R + PD \qquad ( 4 )$$

In an embodiment, the text coherence value is computed based on the moving average semantic similarity as explained below: Initially, the clean textual document is received, and a plurality of sentences are obtained by a sentence tokenization tool. Further, a plurality of sentence segments is generated based on the plurality of sentences such that each segment includes at least one sentence. The size of the segment is predefined. A plurality of window based pairwise similarity scores are computed based on the plurality of sentence segments using the BERT technique by: (i) computing a first semantic similarity score between a first sentence segment from the plurality of sentence segments and a second sentence segment from the plurality of sentence segments and (ii) computing a second semantic similarity score between the second sentence segment from the plurality of sentence segments and a third sentence segment from the plurality of sentence segments by moving a predefined window. The semantic similarity score computation is continued until each of the plurality of sentence segments are compared. Further, a plurality of combined similarity scores are computed based on the plurality of sentence segments using the BERT technique by: (i) computing a first combined similarity score between the first sentence segment and the second sentence segment (ii) computing a second combined similarity score between the first sentence segment, the second sentence segment and the third sentence segment; and (iii) computing a third combined similarity score between the first sentence segment, the second sentence segment, the third sentence segment and a fourth sentence segment. The combined similarity score computation is continued until each of the plurality of sentence segments are compared. Finally, the text coherence value is computed by averaging the plurality of window based pairwise similarity scores and plurality of combined similarity scores.

The method of computing text coherence value is explained using the following pseudocode.

Pseudocode: Text coherence value computation

| Input: the sentence set S = {S_1, S_2, S_3, S_4, ... S_n − 1, S_n} | |
|---|---|
| Output: The text coherence value Sc | |
| 1. | Initialize Sc1 = 0; #Initialize the Threshold value T to identify the |
| | continuation of the sentence |
| 2. | set threshold T |
| 3. | Dis = [ ] |
| | # Calculate the average of LSAs of consecutive sentences |
| 4. | For i = 1 to n−1 do: |
| 5. | Ls1[i] = LSA of S_i and S_i + 1 |
| 6. | Sc1 = Sc1 + Ls1[i] |
| 7. | end do |
| 8. | Sc1 = Sc1/(n − 1) |
| | # Calculate the LSAs of n'th sentence with all previous sentences |
| 9. | For i = 1 to n − 1 do: |
| 10. | Ls[i] = LSA of D_i and S_i + 1; where D_i = {S_1, S_2, ... S_i} |
| 11. | end do |
| | # Separate the continuous portions using the threshold T |
| 12. | For i = 0 to n − 1 do: |
| 13. | If Ls[i] < T do: |
| 14. | Put ‘i’ in Dis |
| 15. | End do |
| 16. | End do |
| 17. | M = size of Dis (number of element in Dis) |
| 18. | put ‘n’ in Dis |
| | # Calculate the average of each continuous portions |
| 19. | For j = 1 to M do: |
| 20. | F_j = F_j + Ls[k] for k from Dis[j] to min(Dis[j],Dis[j + 1] − 1) |
| 21. | If Dis[j + 1] ! = D[j] do: |
| 22. | F_j = F_j / (Dis[j + 1] − D[j]) |
| 23. | End do |
| 24. | End do |
| 25. | Set Sm = 0 |
| 26. | For j = 1 to M do: |
| 27. | Sm = Sm + F_j |
| 28. | end do |
| 29. | Sc2 = Sm/(M\hat{ }2) |
| | # Compute Average of two scores |
| 30. | Sc = (Sc1 + Sc2)/2; |

The pseudocode is including two parts. The first part (line number 4 to 8) computes the pair wise semantic similarity between pair of segments. In the second part (line numbers 9 to 11), the segments are combined together and the similarity between each combined segment with the next available segment is computed. Further, the portion of the text where segment similarity drops below a predefined threshold T is identified (line number 12 to 18). Further, in line number 19 to 29, the average similarity score of each of the continuous portions are computed. Finally, the average (line number 30) of the similarity between the pairwise segments obtained in the first part and the combined segment as computed in the second part is computed.

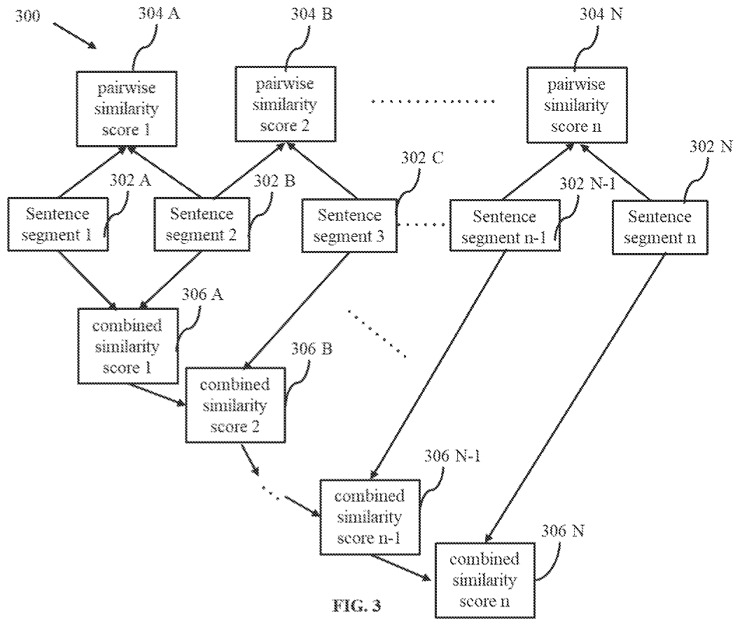

FIG. 3 is an exemplary flow diagram 300 for text coherence computation for the processor implemented method for machine learning based professional written communication skill assessment implemented by the system of FIG. 1, in accordance with some embodiments of the present disclosure. Now referring to FIG. 3. The plurality of sentence segments is represented as 302A, 302B . . . 302N. Here, the first sentence segment 302A is compared with the second sentence segment 302B and a first pairwise similarity score 304A is obtained. Further, the second sentence segment 302B is compared with the third sentence segment 302C and the second pairwise similarity score 304C (not shown in FIG. 3) is obtained. Similarly, the plurality of pairwise similarity scores are obtained. Further, the first combined similarity score 306A is computed between the first sentence segment 302A and the second sentence segment 302B. Further, the second combined similarity score 306B is computed between the first sentence segment 302A, the second sentence segment 302B and the third sentence segment 302C. Further, a third combined similarity score 306C (Not shown in FIG. 3) is computed based on a comparison between the first sentence segment, the second sentence segment, the third sentence segment and a fourth sentence segment. The combined similarity score computation is continued until each of the plurality of sentence segments are compared. Finally, the text coherence value is computed by averaging the plurality of window based pairwise similarity scores and plurality of combined similarity scores.

At step 208 of the method 200, the one or more hardware processors 102 are configured by the programmed instructions to simultaneously compute a plurality of psychological features based on the clean textual data using a psycholinguistic analysis. The plurality of psychological features includes a plurality of affective features, a plurality of social skills, a plurality of cognitive skills, a plurality of perceptual skills and a plurality of biological features. The plurality of biological features includes a body state, a plurality of symptoms, a gender and a sexuality, an eating habit, a drinking habit, a dieting habit, a sleeping nature, a dreaming, and a grooming. The plurality of affective features includes a positive emotion, a negative emotion, an optimism and energy, an anxiety, an anger, a sadness and a fear. The plurality of perceptual skills includes a seeing ability, a hearing ability and a feeling. The plurality of social skills includes a reference to people, a reference to friends, a reference to family and a reference to relatives. The plurality of cognitive skills includes a causation, an insight, a discrepancy, an inhibition, and a certainty.

In an embodiment, the plurality of psychological features are computed by Linguistic Information and Word Count (LIWC). The LIWC uses its internal dictionary to assign words used in a text document to different pre-determined psychologically meaningful categories. Empirical results using LIWC already demonstrated its ability to detect a wide variety of psychological markers like attentional focus, emotionality, social relationships, thinking styles and individual differences. The LIWC categorizes words into 64 categories. This psycholinguistic analysis module returns the final score for each of these 64 categories as output by the LIWC tool, within a range of 0 to 1.

At step 210 of the method 200, the one or more hardware processors 102 are configured by the programmed instructions to compute a concatenated feature vector based on the plurality of linguistic features and plurality of psychological features using a first Fully Connected Neural Network (FCNN). For example, the concatenated feature vector looks like [0.02,0.04,0.01,0.0,0.5,0.06, . . . ,0.09]_{1×92}

At step 218 of the method 200, the one or more hardware processors 102 are configured by the programmed instructions to simultaneously compute a contextual embedding based on the clean textual data using a Bidirectional Encoding Representations from Transformers (BERT) technique.

In an embodiment, the BERT technique is a multi-layer bidirectional Transformer encoder based on the original transformer model. The input representation is a concatenation of Word-Piece embeddings, positional embeddings, and the segment embedding of the entire document. Here fine-tuning is performed to 800 steps in order to prevent over-fitting. The batch size is 32, a maximum sequence length of 128 with a learning rate of 2*10⁵.

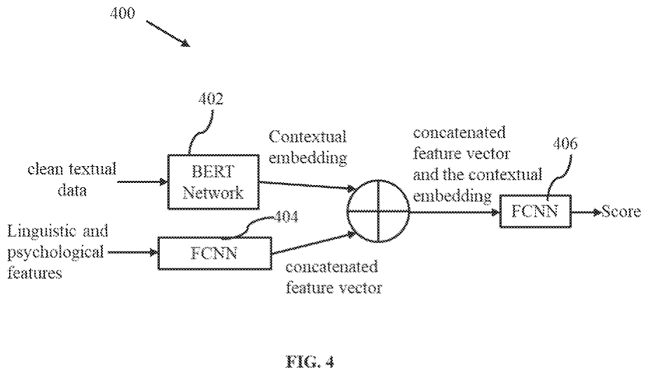

At step 218 of the method 200, the one or more hardware processors 102 are configured by the programmed instructions to evaluate a professional written communication skill of the user under assessment based on the concatenated feature vector and the contextual embedding by a second FCNN. The professional written communication skill evaluator is described using FIG. 4. In an embodiment, a concatenated feature includes 72 dimensional linguistic feature vectors. The BERT architecture used here is Linguistic-BERT (Li-BERT) technique. Further, the combined 72 dimensional linguistic feature vectors and the contextual embeddings are passed over the SoftMax FCNN to obtain a communication skill score within a range of [0, 1].

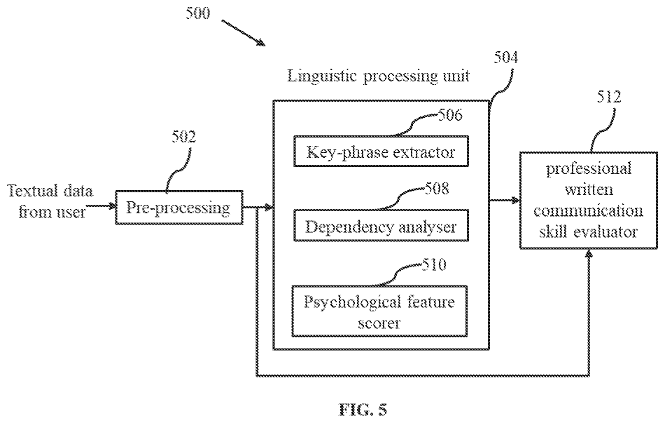

FIG. 4 illustrates the machine learning architecture (400) for evaluating professional written communication skill implemented by the system of FIG. 1, in accordance with some embodiments of the present disclosure. Now referring to FIG. 4, the machine learning architecture includes a BERT network 402 for computing contextual embedding of the input clean textual data, the first FCNN 404 and the second FCNN 406. The first FCNN 404 is used for computing the concatenated feature vector from the plurality of linguistic features and the plurality of psychological features. The second FCNN 406 is used for evaluating the profession written communication skill of the user based in the concatenated feature vector and the contextual embedding. The second FCNN uses a SoftMax function to compute a final score of the user. FIG. 5 illustrates an example overall architecture (500) for the processor implemented method for machine learning based professional written communication skill assessment implemented by the system of FIG. 1, in accordance with some embodiments of the present disclosure. Now referring to FIG. 3, the architecture includes a pre-processing module 502, a linguistic processing unit 504 and a professional written communication skill evaluator 512. The pre-processing module 502 receives the textual data from the user and removes the plurality of irrelevant data and generates the clean textual data. The clean textual data is given as input to the linguistic processing unit 504. The linguistic processing unit 504 includes a key-phrase extractor 506, a dependency analyzer 508 and a psychological feature extractor 510. The linguistic processing unit 504 computes the plurality of linguistic features based on the clean textual data. The plurality of linguistic features includes a plurality of dependency relationship values computed by the dependency analyzer 508, a text coherence value and a lexical diversity value computed based on the key-phrase extractor 506. The text coherence value is computed based on a moving average semantic similarity. The lexical density score is computed based on a phrasal density. The psychological feature extractor 510 generates the plurality of psychological features. The plurality of linguistic features and the psychological features are given as input to the professional written communication skill evaluator 512. The professional written communication skill evaluator 512 includes the BERT architecture to compute the contextual embeddings from the clean textual data, the first FCNN to compute the concatenated feature vector from the plurality of linguistic features and the psychological features and the second SoftMax FCNN to evaluate the professional written communication score of the user based on the concatenated feature vector and the contextual embeddings.

The present disclosure is experimented in openly available essay assessment dataset with 8 different subsets. Several techniques were used to measure the quality of written communication skill assessment. This includes Pearson's correlation, Spearman's ranking correlation, Kendall's Tau and kappa, and quadratic weighted kappa (QWK). It is observed that the performance of the present linguistically enhanced neural network architecture is at par with the current state of the art models across all the given evaluation parameters.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address the unresolved problem of machine learning based professional written communication skill assessment. The present disclosure provides an efficient machine learning based approach for evaluating the profession written communication skill of the user. Here, the sentence coherence and the lexical diversity are computed in a unique way which increases the performance of the system. Further, the combined Li-BERT and FCNN architectures increases accuracy of the system 100.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, the method comprising:
receiving, by one or more hardware processors, a textual data written by a user, wherein the textual data comprises a plurality of sentences, wherein each of the plurality of sentences comprises a plurality of words;
obtaining, by the one or more hardware processors, a clean textual data by eliminating a plurality of irrelevant data from the textual data;
computing, by the one or more hardware processors, a plurality of linguistic features based on the clean textual data using a linguistic analysis technique, wherein the plurality of linguistic features comprises a plurality of dependency relationship values, a text coherence value and a lexical diversity value, wherein the text coherence value is computed based on a moving average semantic similarity and the lexical density score is computed based on a phrasal density;
simultaneously computing, by the one or more hardware processors, a plurality of psychological features based on the clean textual data using a psycholinguistic analysis;
computing, by the one or more hardware processors, a concatenated feature vector based on the plurality of linguistic features and plurality of psychological features using a first Fully Connected Neural Network (FCNN);
simultaneously computing, by the one or more hardware processors, a contextual embedding based on the clean textual data using a Bidirectional Encoding Representations from Transformers (BERT) technique; and
evaluating, by the one or more hardware processors, a professional written communication skill of the user based on the concatenated feature vector and the contextual embedding using a second FCNN.

2. The processor implemented method of claim 1, wherein the step of computing the lexical density score based on the phrasal density value further comprising:
receiving the clean textual data;
obtaining a plurality of key-phrases from the clean textual data using a key phrase extractor, wherein each of the plurality of key-phrases is associated with a corresponding score;
computing a phrasal density value based on a total number of key-phrases and a total number of phrases, wherein a total number of key-phrases are computed based on the plurality of key-phrases, wherein a total number of phrases are obtained from the clean textual data by computing a frequency of occurrence of Nouns, Verbs, Adjectives and Adverbial phrases by a Stanford Dependency Parsing Tool; and
computing a lexical diversity value based on an average type-token ratio for each of the plurality of key-phrases and the phrasal density, wherein the average type-token ratio is computed based on a ratio between a number of unique words in the clean textual data and a total number of words in the clean textual data.

3. The processor implemented method of claim 1, wherein the step of computing the text coherence value based on the moving average semantic similarity further comprising:
receiving the clean textual document;
obtaining a plurality of sentences associated with the clean textual data using a sentence tokenization tool;
generating a plurality of sentence segments based on the plurality of sentences such that each segment comprises at least one sentence, wherein the size of the segment is predefined;
computing a plurality of window based pairwise similarity scores based on the plurality of sentence segments using the BERT technique by:
computing a first semantic similarity score based on a comparison between a first sentence segment from the plurality of sentence segments and a second sentence segment from the plurality of sentence segments; and
computing a second semantic similarity score based on a comparison between the second sentence segment from the plurality of sentence segments and a third sentence segment from the plurality of sentence segments by moving a predefined window, wherein the semantic similarity score computation is continued until each of the plurality of sentence segments are compared;
computing a plurality of combined similarity scores based on the plurality of sentence segments using the BERT technique by:
computing a first combined similarity score based on a comparison between the first sentence segment and the second sentence segment;
computing a second combined similarity score based on a comparison between the first sentence segment, the second sentence segment and the third sentence segment;
computing a third combined similarity score based on a comparison between the first sentence segment, the second sentence segment, the third sentence segment and a fourth sentence segment, wherein the combined similarity score computation is continued until each of the plurality of sentence segments are compared; and
computing the text coherence value by averaging the plurality of window based pairwise similarity scores and plurality of combined similarity scores.

4. The processor implemented method of claim 1, wherein the plurality of dependency relationships is computed using Stanford dependency parser, wherein each of the plurality of dependency relationships are associated with a corresponding dependency score.

5. The processor implemented method of claim 1, wherein the plurality of affective features comprises positive emotion, negative emotion, optimism and energy, anxiety, anger, sadness and fear.

6. The processor implemented method of claim 1, wherein the plurality of social skills comprises a reference to people, a reference to friends, a reference to family and a reference to relatives, and wherein the plurality of cognitive skills comprises a causation, an insight, a discrepancy, an inhibition, and a certainty.

7. The processor implemented method of claim 1, wherein the plurality of perceptual skills comprises seeing ability, hearing ability and feeling.

8. The processor implemented method of claim 1, wherein the plurality of psychological features comprises a plurality of affective features, a plurality of social skills, a plurality of cognitive skills, a plurality of perceptual skills and a plurality of biological features, and wherein the plurality of biological features comprises body state, a plurality of symptoms, gender and sexuality, eating habit, drinking habit, dieting habit, sleeping nature, dreaming, and grooming.

9. The processor implemented method of claim 1, wherein the plurality of details pertaining to the user under assessment comprises a name, an address, an identification number, a phone number and an email ID.

10. The method of claim 1, wherein the plurality of irrelevant data comprises a plurality of non-ASCII characters, a plurality of hyperlinks, a plurality of html tags, a plurality of URL markers, a plurality of line break markers and a plurality of details pertaining to the user under assessment.

11. A system comprising:
at least one memory storing programmed instructions; one or more Input/Output (I/O) interfaces; and one or more hardware processors operatively coupled to the at least one memory , wherein the one or more hardware processors are configured by the programmed instructions to:
receive textual data written by a user, wherein the textual data comprises a plurality of sentences, wherein each of the plurality of sentences comprises a plurality of words;
obtain a clean textual data by eliminating a plurality of irrelevant data from the textual data;
compute a plurality of linguistic features based on the clean textual data using a linguistic analysis technique, wherein the plurality of linguistic features comprises a plurality of dependency relationship values, a text coherence value and a lexical diversity value, wherein the text coherence value is computed based on a moving average semantic similarity and the lexical density score is computed based on a phrasal density;
simultaneously compute a plurality of psychological features based on the clean textual data using a psycholinguistic analysis;
compute a concatenated feature vector based on the plurality of linguistic features and plurality of psychological features using a first Fully Connected Neural Network (FCNN);
simultaneously compute a contextual embedding based on the clean textual data using a Bidirectional Encoding Representations from Transformers (BERT) technique; and
evaluate a professional written communication skill of the user based on the concatenated feature vector and the contextual embedding using a second FCNN.

12. The system of claim 11, wherein the step of computing the lexical density score based on the phrasal density value further comprising:
receiving the clean textual data;
obtaining a plurality of key-phrases from the clean textual data using a key phrase extractor, wherein each of the plurality of key-phrases is associated with a corresponding score;
computing a phrasal density value based on a total number of key-phrases and a total number of phrases, wherein a total number of key-phrases are computed based on the plurality of key-phrases, wherein a total number of phrases are obtained from the clean textual data by computing a frequency of occurrence of Nouns, Verbs, Adjectives and Adverbial phrases by a Stanford Dependency Parsing Tool; and
computing a lexical diversity value based on an average type-token ratio for each of the plurality of key-phrases and the phrasal density, wherein the average type-token ratio is computed based on a ratio between a number of unique words in the clean textual data and a total number of words in the clean textual data.

13. The system of claim 11, wherein the step of computing the text coherence value based on the moving average semantic similarity further comprising:
receiving the clean textual document;
obtaining a plurality of sentences associated with the clean textual data using a sentence tokenization tool;
generating a plurality of sentence segments based on the plurality of sentences such that each segment comprises at least one sentence, wherein the size of the segment is predefined;
computing a plurality of window based pairwise similarity scores based on the plurality of sentence segments using the BERT technique by:
computing a first semantic similarity score based on a comparison between a first sentence segment from the plurality of sentence segments and a second sentence segment from the plurality of sentence segments; and
computing a second semantic similarity score based on a comparison between the second sentence segment from the plurality of sentence segments and a third sentence segment from the plurality of sentence segments by moving a predefined window, wherein the semantic similarity score computation is continued until each of the plurality of sentence segments are compared;
computing a plurality of combined similarity scores based on the plurality of sentence segments using the BERT technique by:
computing a first combined similarity score based on a comparison between the first sentence segment and the second sentence segment;
computing a second combined similarity score based on a comparison between the first sentence segment, the second sentence segment and the third sentence segment;
computing a third combined similarity score based on a comparison between the first sentence segment, the second sentence segment, the third sentence segment and a fourth sentence segment, wherein the combined similarity score computation is continued until each of the plurality of sentence segments are compared; and
computing the text coherence value by averaging the plurality of window based pairwise similarity scores and plurality of combined similarity scores.

14. The system of claim 11, wherein the plurality of dependency relationships is computed using Stanford dependency parser, wherein each of the plurality of dependency relationships are associated with a corresponding dependency score.

15. The system of claim 11, wherein the plurality of affective features comprises positive emotion, negative emotion, optimism and energy, anxiety, anger, sadness and fear.

16. The system of claim 11, wherein the plurality of social skills comprises a reference to people, a reference to friends, a reference to family and a reference to relatives, and wherein the plurality of cognitive skills comprises a causation, an insight, a discrepancy, an inhibition, and a certainty and, wherein the plurality of perceptual skills comprises seeing ability, hearing ability and feeling.

17. The system of claim 11, wherein the plurality of psychological features comprises a plurality of affective features, a plurality of social skills, a plurality of cognitive skills, a plurality of perceptual skills and a plurality of biological features, and wherein the plurality of biological features comprises body state, a plurality of symptoms, gender and sexuality, eating habit, drinking habit, dieting habit, sleeping nature, dreaming, and grooming.

18. The system of claim 11, wherein the plurality of details pertaining to the user under assessment comprises a name, an address, an identification number, a phone number and an email ID.

19. The system of claim 11, wherein the plurality of irrelevant data comprises a plurality of non-ASCII characters, a plurality of hyperlinks, a plurality of html tags, a plurality of URL markers, a plurality of line break markers and a plurality of details pertaining to the user under assessment.

20. One or more non-transitory machine-readable information storage mediums comprising one or more instructions which when executed by one or more hardware processors cause:
receiving a textual data written by a user, wherein the textual data comprises a plurality of sentences, wherein each of the plurality of sentences comprises a plurality of words;
obtaining a clean textual data by eliminating a plurality of irrelevant data from the textual data;
computing a plurality of linguistic features based on the clean textual data using a linguistic analysis technique, wherein the plurality of linguistic features comprises a plurality of dependency relationship values, a text coherence value and a lexical diversity value, wherein the text coherence value is computed based on a moving average semantic similarity and the lexical density score is computed based on a phrasal density;
simultaneously computing a plurality of psychological features based on the clean textual data using a psycholinguistic analysis;
computing a concatenated feature vector based on the plurality of linguistic features and plurality of psychological features using a first Fully Connected Neural Network (FCNN);
simultaneously computing a contextual embedding based on the clean textual data using a Bidirectional Encoding Representations from Transformers (BERT) technique; and
evaluating a professional written communication skill of the user based on the concatenated feature vector and the contextual embedding using a second FCNN.
